(19) United States
(12) Patent Application Publication
(10) Pub. No.: US 2011/0169312 A1
(43) Pub. Date: Jul. 14, 2011

(54) Hinge Device Having a Reinforced Collar

(75) Inventors: Sylvain Desquesne, Conde Sur Noireau (FR); Sébastien Gautier, Flers (FR); Benoît Hanriot, Caligny (FR)

(73) Assignee: Faurecia Sieges d'Automobile, Nanterre (FR)

(21) Appl. No.: 12/985,813

(22) Filed: Jan. 6, 2011

(30) Foreign Application Priority Data
Jan. 11, 2010 (FR) 10 50147

(51) Int. Cl. B60N 2/225

(52) U.S. Cl. 297/362

(57) ABSTRACT

A hinge device comprising:
a first cheek plate and a second cheek plate meshing with each other, and one of which is designed to be secured to the seat proper while the other is designed to be secured to the seat back, said first cheek plate being provided with a collar and with a non-slit ring fastened to the collar, the collar having an outside surface extending along a first axis, and said second cheek plate having a cylindrical inside surface extending along a second axis parallel to and distant from said first axis;
an eccentric mechanism mounted to move in rotation about one axis from among the first axis and the second axis, and interconnecting the first cheek plate and the second cheek plate, said ring being interposed between the collar and the eccentric mechanism; and
a control mechanism for turning the eccentric mechanism and for driving the first cheek plate relative to the second cheek plate.

### FIELD OF THE INVENTION

The invention relates to a hinge device designed to adjust the inclination of a seat back of a vehicle seat relative to a seat proper thereof.

### BACKGROUND OF THE INVENTION

Document FR-2 902 375 discloses a hinge device referred to as being of the “continuous adjustment” type, and that comprises:
a first cheek plate and a second cheek plate meshing with each other, and one of which is designed to be secured to the seat proper while the other is designed to be secured to the seat back, said first cheek plate being provided with a collar and with a ring fastened to the collar, the collar having a cylindrical outside surface extending along a first axis, the ring having a cylindrical inside surface coming directly into contact with the outside surface of the collar, and said second cheek plate having a cylindrical inside surface extending along a second axis parallel to and distant from said first axis;
an eccentric mechanism mounted to move in rotation about one axis from among the first axis and the second axis, and interconnecting the first cheek plate and the second cheek plate, said ring being interposed between the collar and the eccentric mechanism; and
a control mechanism for turning the eccentric mechanism and for driving the first cheek plate relative to the second cheek plate.

In Document FR-2 902 375, the ring is covered with a coating that is easier and less costly to make on said ring than directly on the collar. That coating makes it possible to reduce the friction generated by the eccentric mechanism moving in rotation and thus to reduce the force to be applied to the control mechanism for adjusting the inclination of the seat back. That ring is axially slit, and is of small thickness. It is thus easy to mount the ring on the collar.

### SUMMARY OF THE INVENTION

An object of the invention is to improve the robustness of the hinge device, in particular the strength thereof in the event of very high stress, due to an impact.

To this end, according to the invention, the ring is not (axially) slit. In other words it extends continuously over its entire circumference.

It is found that this significantly increases the strength of the hinge device. The collar is still subjected to the same stresses, but the stresses exerted on the collar are distributed over a larger area, thereby reducing the maximum stress exerted on the collar. Thus, although it is more complex to mount the ring on the collar, it is found that the invention procures a considerable advantage as regards reducing the risk of the hinge device being damaged.

According to another characteristic of the invention, the collar preferably has a cylindrical inside surface, and the control mechanism has an annular portion having an outside surface extending facing the inside surface of the collar and made of a plastics material.

The invention thus makes it possible to reduce the cost and the weight of the hinge device by making at least a portion of the control mechanism of plastic, without reducing the robustness of said control mechanism, by means of the improvement in the distribution of the stresses that is procured by the non-slit ring.

According to another characteristic of the invention, the ring is preferably force fitted over the collar.

The contribution made by the ring to withstanding any forces is thus increased and the ring is held easily on the collar.

According to an additional characteristic of the invention, the outside surface of the collar has a diameter that is greater than the diameter of the inside surface of the ring by in the range one hundredth of a millimeter to two tenths of a millimeter.

Co-operation between the collar and the ring is thus particularly advantageous.

According to another characteristic of the invention, the ring has a thickness lying in the range 2 millimeters (mm) to 3 mm.

The ring thus reinforces the collar effectively without significantly increasing the overall size or the weight of the hinge device.

According to another characteristic of the invention, the ring is preferably made of a sintered material.

It is thus easy to obtain high strength characteristics making it possible to procure good reinforcement of the collar.

According to yet another characteristic of the invention, the ring preferably has Vickers hardness lying in the range 600 Hv_{0.1} to 800 Hv_{0.1}.

Such characteristics contribute effectively to procuring a further reinforcement of the collar.

Preferably, according to the invention, the hinge device also has the following characteristics:
the first cheek plate has a base portion that extends radially relative to the first axis;
the collar extends along the first axis between a base end and a free end;
the collar is secured to the base portion via its base end; and
the ring extends to the base end of the collar and is in abutment on the base portion.

The ring thus contributes even more effectively to reinforcing the collar.

According to the invention, the hinge device also preferably has the following characteristics:
the eccentric device has two eccentric elements that are urged by a resilient element, each of the eccentric elements having an inside surface that, in section, has an inside portion of a circle centered on the first axis and an outside surface that, in section, has an outside portion of a circle extending about the second axis; and
the control mechanism has two drive portions suitable for coming into abutment against the eccentric elements for driving them in rotation.

According to yet another characteristic of the invention, the ring preferably has a cylindrical outside surface that comes directly into contact with the inside surface of each of the eccentric elements.

### BRIEF DESCRIPTION OF THE DRAWINGS

Other characteristics and advantages of the present invention appear from the following detailed description given with reference to the accompanying drawings, in which:

FIG. 1 is a diagrammatic view of a seat equipped with a hinge device in accordance with the invention;

FIG. 2 is an exploded perspective view of the device equipping the seat of FIG. 1;

FIG. 3 is a cross-section view of the hinge device on a line referenced in FIG. 1; and

FIG. 4 is a fragmentary view on a larger scale in the zone referenced IV in FIG. 3.

### MORE DETAILED DESCRIPTION

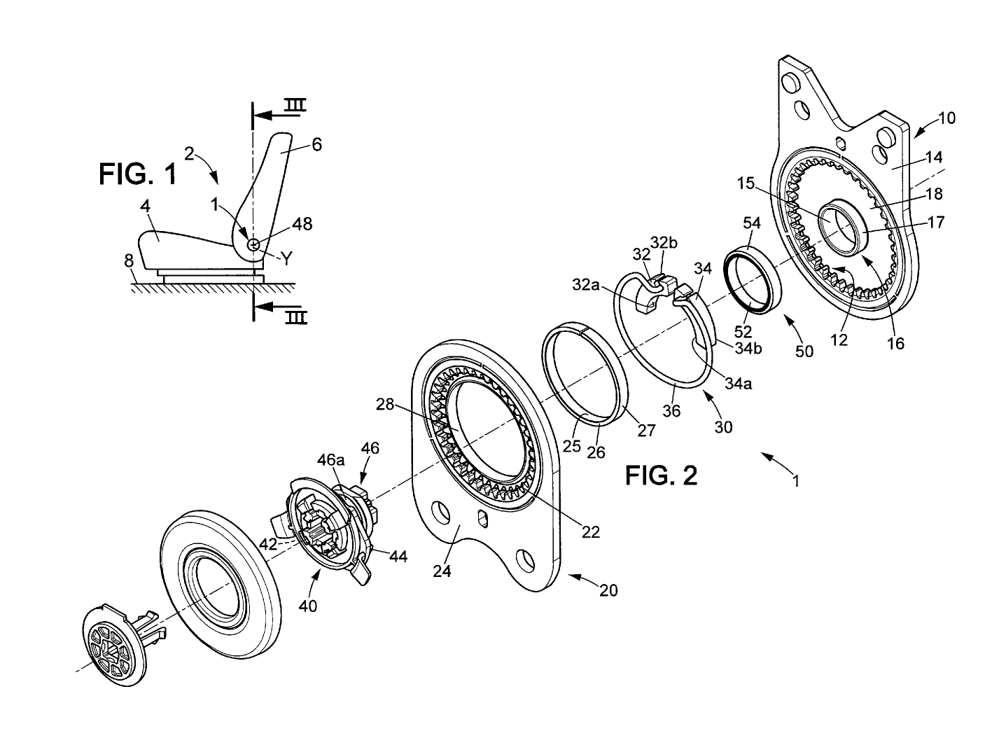

FIG. 1 shows a motor vehicle front seat 2 that comprises a seat proper 4 and a seat back 6 that is mounted to pivot on the seat proper 4 about a horizontal transverse axis Y. The seat proper 4 is mounted on a vehicle floor 8 via runners.

The user can adjust the inclination of the seat back 6 by turning a control knob 48 for controlling a hinge device 1 that is shown in more detail in FIGS. 2 to 4. The hinge device 1 essentially comprises a first metal cheek plate 10 provided with an inside set of teeth 12, a second metal cheek plate 20 provided with an outside set of teeth 22, an eccentric mechanism 30 interconnecting the first cheek plate 10 and the second cheek plate 20, and a control mechanism 40.

For easier understanding, only the first cheek plate 10 is shown in FIG. 4.

In this example, the first metal cheek plate 10 is fastened to the seat back 6. The first cheek plate 10 is essentially made up of a hinge fitting 14 and of a ring 50. The hinge fitting 14 is advantageously formed by die-stamping or stamping a metal plate. It incorporates the inside set of teeth 12 centered on a first transverse axis Y, a collar 16, and a base portion 18 forming a plane annulus extending radially to said first transverse axis Y between the collar 16 and the inside set of teeth 12.

The collar 16 is tubular and extends along a first transverse axis Y between a base 16a connected to the base portion 18 of the first cheek plate 10 and a free end 16b. The collar 16 has a cylindrical inside surface 15 and a cylindrical outside surface 17 that are of circular section and that extend coaxially about the first transverse axis Y.

The ring 50 is cylindrical, of circular section, and coaxial about the first transverse axis Y. It has an inside surface 52 and an outside surface 54. It is engaged over the collar 16. It extends along the first transverse axis Y substantially from the free end 16b of the collar 16 to the base end 16a of the collar 16 and comes into abutment against the base portion 18 of the hinge fitting 14.

Between its inside surface 52 and its outside surface 54, the ring 50 has a thickness e that preferably lies in the range 2 mm to 3 mm. The thickness e of the ring 50 is substantially constant over the entire circumference thereof. In particular, the ring 50 is not slit.

The ring 50 has an inside diameter D₅₂ that is slightly less than the outside diameter D₁₇ of the collar 16, and preferably less than said outside diameter by in the range one hundredth of a millimeter to two tenths of a millimeter. Thus, the outside surface 17 of the collar 16 and the inside surface 52 of the ring 50 are tight fitted. The ring 50 is thus engaged by force over the collar 16, to which it is fastened by tight fitting.

The ring 50 is very hard, its hardness advantageously lying in the range 600 Hv_{0.1} to 800 Hv_{0.1}. To this end, it is preferably made of a sintered material.

The outside surface 54 of the ring 50 may be covered with a coating, in particular a coating of polytetrafluoroethylene, in order to reduce the friction of the eccentric mechanism 30 coming into contact with said coating.

In this example, the second cheek plate 20 is fastened to the structure of the seat proper 4. The second cheek plate 20 is essentially made up of a hinge fitting 24 and of a ring 26. The hinge fitting 24 is advantageously formed by die-stamping or stamping a metal plate, and it incorporates the outside set of teeth 22. The outside set of teeth 22 is centered on a second transverse axis Y′ that is parallel to the first transverse axis Y, but that is offset relative thereto. The hinge fitting 24 is also provided with a locking bore 28.

The ring 26 has an inside surface 25 and an outside surface 27. The inside surface 25 forms a journal-bearing bore. It is cylindrical and of circular to section, and it extends coaxially with the second transverse axis Y′. The outside surface 27 is tightly received in the locking bore 28, so that, in practice, it is secured to the hinge fitting 24. The inside surface 25 of the ring 26 is advantageously covered with a polytetrafluoroethylene coating, in order to reduce the friction of the eccentric mechanism 30 coming into contact with it. Alternatively the ring 26 could be omitted.

The eccentric mechanism 30 comprises two wedge segments forming cams 32, 34 and a resilient annular element 36. The cams 32, 34 are interposed between the ring 50 of the first cheek plate 10 and the ring 26 of the second cheek plate 20. The cams 32, 34, have inside surfaces 32a, 34a forming circular portions centered on the first transverse axis Y and coming into contact with the outside surface 54 of the ring 50. The cams 32, 34 also have outside surfaces 32b, 34b forming circular portions centered on the second transverse axis Y′ and coming into contact with the inside surface 25 of the second cheek plate 20. The resilient annular element 36 acts on the cams 32, 34 to move them apart and to reduce the play between the first cheek plate 10 and the second cheek plate 20.

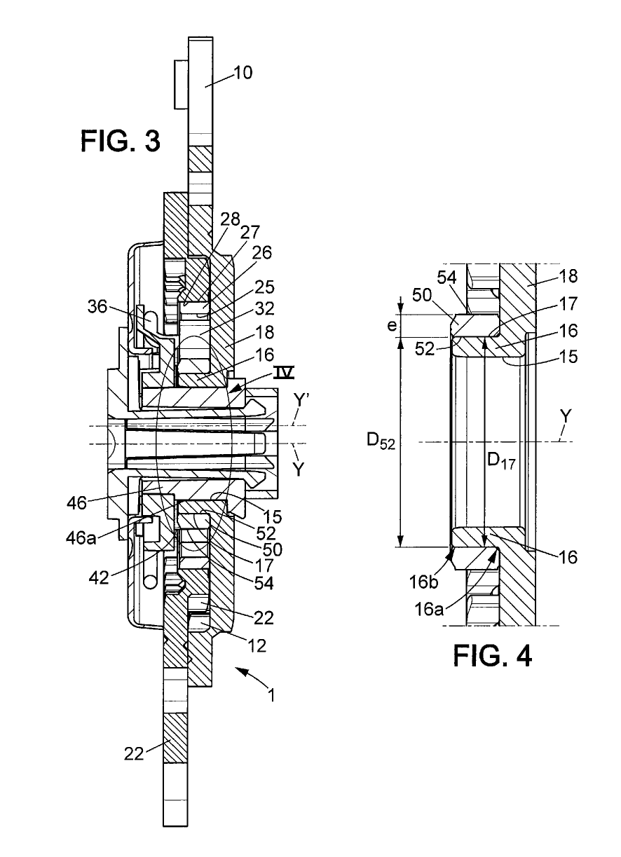

In addition to the control knob 48, the control mechanism 40 further comprises two control fingers 42, 44 and an annular portion 46. The control fingers 42, 44 extend along the transverse axes Y, Y′ and are designed to act on the cams 32, 34 to drive them in rotation. The annular portion 46 is inserted into the collar 16 and has an outside surface 46A extending facing the inside surface 15 of the collar 16. Co-operation between the outside surface 46a of the annular portion of the control mechanism 40 and the inside surface 15 of the collar 16 guides the control mechanism 40 in rotation about the first transverse axis Y. As shown in particular in FIG. 3, the control mechanism 40 is made up of a plurality of elements made of plastic that are snap-fastened in such a manner as to be retained inside the collar 16 along the first transverse axis Y.

1. A hinge device designed to adjust the inclination of a seat back of a vehicle seat relative to a seat proper thereof, said hinge device comprising:
a first cheek plate and a second cheek plate meshing with each other, and one of which is designed to be secured to the seat proper while the other is designed to be secured to the seat back, said first cheek plate being provided with a collar and with a ring fastened to the collar, the collar having a cylindrical outside surface extending along a first axis, the ring having a cylindrical inside surface coming directly into contact with the outside surface of the collar, and said second cheek plate having a cylindrical inside surface extending along a second axis parallel to and distant from said first axis;
an eccentric mechanism mounted to move in rotation about one axis from among the first axis and the second axis, and interconnecting the first cheek plate and the second cheek plate, said ring being interposed between the collar and the eccentric mechanism; and
a control mechanism for turning the eccentric mechanism and for driving the first cheek plate relative to the second cheek plate;
wherein the ring is not slit.

2. The hinge device according to claim 1, wherein:
the collar has a cylindrical inside surface; and
the control mechanism has an annular portion having an outside surface extending facing the inside surface of the collar and made of a plastics material.

3. The hinge device according to claim 1, wherein the ring is force fitted over the collar.

4. The hinge device according to claim 3, wherein the outside surface of the collar has a diameter that is greater than the diameter of the inside surface of the ring by in the range one hundredth of a millimeter to two tenths of a millimeter.

5. The hinge device according to claim 1, wherein the ring has a thickness lying in the range 2 mm to 3 mm.

6. The hinge device according to claim 1, wherein the ring is made of a sintered material.

7. The hinge device according to claim 1, wherein the ring has hardness lying in the range 600 Hv_{0.1} to 800 Hv_{0.1}.

8. The hinge device according to claim 1, wherein:
the first cheek plate has a base portion that extends radially relative to the first axis;
the collar extends along the first axis between a base end and a free end;
the collar is secured to the base portion via its base end; and
the ring extends to the base end of the collar and is in abutment on the base portion.

9. The hinge device according to claim 1, wherein:
the eccentric device has two eccentric elements that are urged by a resilient element, each of the eccentric elements having an inside surface that, in section, has an inside circular portion centered on the first axis and an outside surface that, in section, has an outside circular portion extending about the second axis; and
the control mechanism has two drive portions suitable for coming into abutment against the eccentric elements for driving them in rotation.

10. The hinge device according to claim 9, wherein the ring has a cylindrical outside surface that comes directly into contact with the inside surface of each of the eccentric elements.
